(19) United States
(12) Patent Application Publication
(10) Pub. No.: US 2005/0001055 A1
(43) Pub. Date: Jan. 6, 2005

(54) Fuel injector assembly

(76) Inventor: Jens Gebhardt, Columbia, SC (US)

Correspondence Address: McGuireWoods LLP, Suite 1800, 1750 Tysons Boulevard, McLean, VA, 22102-4215, US

(21) Appl. No.: 10/609,406

(22) Filed: Jul. 1, 2003

(51) Int. Cl. F02M 47/02

(52) U.S. Cl. 239/88; 239/533.3; 239/584

(57) ABSTRACT

An oil activated fuel injector includes a control valve body with end cap solenoids and a slidably mounted spool. An element is arranged on a portion of the spool for minimizing latching effects of the slidably mounted spool. A drainage system may be formed in the fuel injector for reducing oil accumulation between the end cap and the control valve body. Additionally, a minimized surface area may be formed on the end of the spool or one or both of the end caps. The minimized surface area may be a raised portion of different dimensions also minimizes the latching effects.

### BACKGROUND OF THE INVENTION

1. Field of the Invention

The present invention generally relates to a fuel injector and, more particularly, to a fuel injector that optimizes the fuel delivery and minimizes erratic injection behavior due to latching effects.

2. Background Description

There are many types of fuel injectors designed to inject fuel into a combustion chamber of an engine. For example, fuel injectors may be mechanically, electrically or hydraulically controlled in order to inject fuel into the combustion chamber of the engine. In the hydraulically actuated systems, a control valve body may be provided with two, three or four way valve systems, each having grooves or orifices which allow fluid communication between working ports, high pressure ports and venting ports of the control valve body of the fuel injector and the inlet area. The working fluid is typically engine oil or other types of suitable hydraulic fluid capable of providing a pressure within the fuel injector in order to begin the process of injecting fuel into the combustion chamber.

In current designs, a driver will deliver a current or voltage to an open side of an open coil solenoid. The magnetic force generated in the open coil solenoid will shift a spool into the open position so as to align grooves or orifices (hereinafter referred to as “grooves”) of the control valve body and the spool. The alignment of the grooves permits the working fluid to flow into an intensifier chamber from an inlet portion of the control valve body (via working ports). The high-pressure working fluid then acts on an intensifier piston to compress an intensifier spring and hence compress fuel located within a high-pressure plunger chamber. As the pressure in the high-pressure plunger chamber increases, the fuel pressure will begin to rise above a needle check valve opening pressure. At the prescribed fuel pressure level, the needle check valve will shift against the needle spring and open the injection holes in a nozzle tip. The fuel will then be injected into the combustion chamber of the engine.

However, in such conventional systems, over time changes in latching effects between the spool and end caps or solenoids may retard the injection start due to a delayed motion of the spool in the opening direction. For example, the spool may temporarily latch to a solenoid end cap, which delays the spool from moving. In this manner response times between the injection cycles may be slowed thus decreasing the efficiency of the fuel injector. It has been found that fuel injectors have experienced low fuel delivery and/or erratic injector behavior, typically after various run times, for example, 2 to 3000 hours. It has further been found that this reduced efficiency has increased at higher rail pressures. Time delays regarding first injection events at the pulse width map are also frequently observed. This reduction of the fuel quantity may also be accompanied by higher shot to shot variation.

### SUMMARY OF THE INVENTION

In a first aspect of the invention, a valve control body includes a control body and opposing solenoid coils positioned at respective ends of the control body. A spool is positioned within a bore of the control body and between the opposing solenoid coils. The spool includes a mechanism which at least minimizes fluid accumulation between an end of the spool and at least one of the opposing solenoid coils. In embodiments, the mechanism may be a groove, a seal seated within the groove, a drainage system or a geometric shape which effectuates a pumping action of fluid.

In another aspect of the invention, the valve control body includes a control body and first and second solenoid coils positioned at first and second ends of the control body, respectively. A spool is positioned within the control body between the open and closed solenoid coils and a means is provided for minimizing fluid accumulation between a contact surface area between the spool and one of the first and second solenoid coils. The means may also eliminate or minimize a latching effect between the spool and the first and/or second solenoid coils.

In another aspect of the invention, a fuel injector includes a body control valve having an inlet port and working ports and first and second solenoid coils positioned at opposing ends of the body control valve. A slidably mounted spool is arranged substantially between the first and second solenoid coils. The spool includes a mechanism which at least minimizes fluid accumulation between an end of the spool and at least one of the first and second solenoid coil. An intensifier chamber having a piston and plunger assembly is in fluid communication with the working ports. A high-pressure fuel chamber is arranged below a portion of the plunger and a needle chamber having a needle is responsive to an increased fuel pressure created in the high-pressure fuel chamber.

In yet another aspect, a replacement kit for a valve control body of a fuel injector is provided. The replacement kit includes a spool including an element for reducing or minimizing latching effects between the spool and end caps of the fuel injector.

### BRIEF DESCRIPTION OF THE DRAWINGS

FIG. 1 a shows a cross sectional view of a control valve body according to an embodiment of the invention;

FIG. 1b shows an exploded view of FIG. 1a inside line A to A′;

FIG. 2a shows a cross sectional view of a control valve body according to an embodiment of the invention;

FIG. 2b shows an exploded view of FIG. 2a inside line B to B′;

FIG. 3a shows a cross sectional view of a control valve body according to an embodiment of the invention;

FIG. 3b shows an exploded view of FIG. 3a inside line C to C′;

FIG. 4 shows an exploded cross sectional view of minimized surface area according to an embodiment of the invention;

FIG. 5 shows a graph displaying test results according to embodiments of the invention;

FIG. 6 shows a graph displaying test results according to embodiments of the invention; and

FIG. 7 shows a cross sectional view of a fuel injector assembly according to the invention.

### DETAILED DESCRIPTION OF EMBODIMENTS OF THE INVENTION

The invention is directed to a fuel injector and more particularly to a control valve assembly of the fuel injector. In the invention, latching effects, particularly hydraulic latching effects, are minimized during activation or deactivation of the open or closed solenoids of the fuel injector by removing or eliminating fluid between an end cap and spool of the control valve body. That is, the invention removes or eliminates fluid between either or both sides of the spool and the end caps of the control valve body. By removing or minimizing fluid in this area fuel decay and delayed motions of the spool can be minimized by reducing the accumulated (i.e., damned up) fluid. Although the invention eliminates, reduces or prevents the changes in hydraulic latching effects, it should be understood that the invention may equally relate to magnetic latching effects. The invention may be used as a replacement kit for a fuel injector.

### Embodiments of the Oil Activated Fuel Injector of the Invention

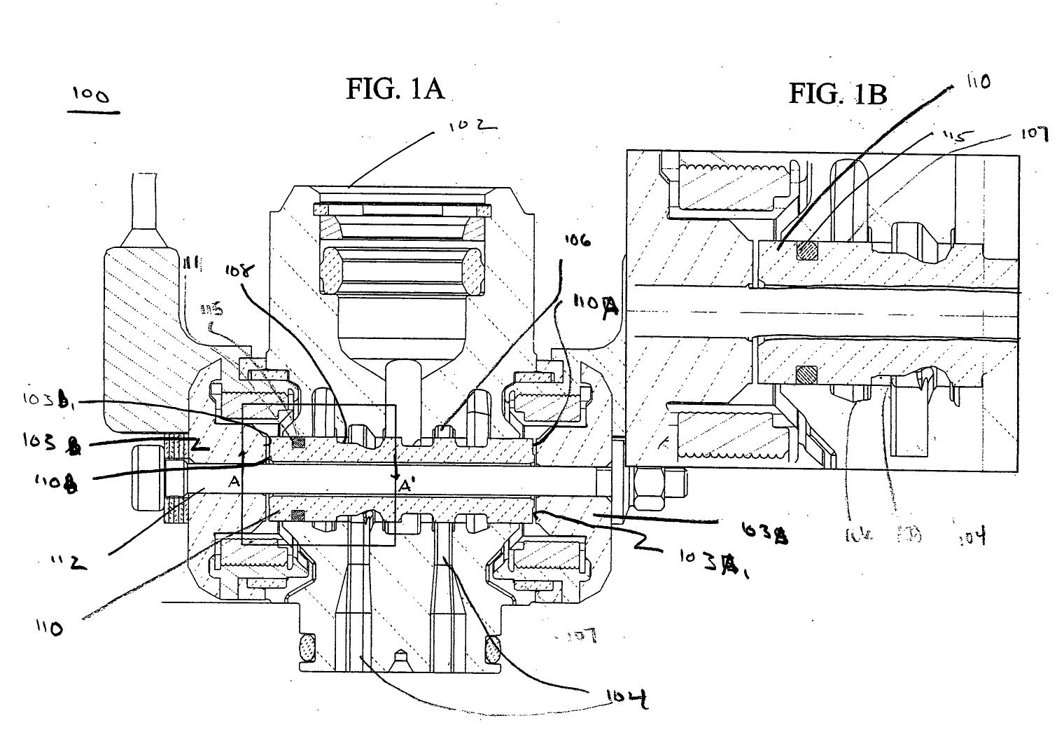

Referring now to FIG. 1a, a control valve body is generally depicted as reference numeral 100. The control valve body 100 includes an inlet area 102, which is in fluid communication with working ports 104. At least one groove or orifice (hereinafter referred to as grooves) 106 is arranged between and in fluid communication with the inlet area 102 and the working ports 104. A spool 110 having at least one groove or orifice (hereinafter referred to as grooves) 108 is slidably mounted within a bore 107 of the control valve body 100. A bolt or type of fastener 112 is arranged through the spool 110 for slidably mounting the spool 110 to the control valve body 100. An open coil assembly 103A and a closed coil assembly 103B, both housed within respective solenoid end cap assemblies, are positioned on opposing sides of the spool 110. The coil assemblies 103A and 103B include a first solenoid contact surface 103A₁ facing a first spool contact surface 110A and second solenoid contact surface 103B₁ facing a second spool contact surface 110B.

Still referring to FIG. 1, the spool 110 includes a groove 111 in which a seal 115 is seated therein. The seal 115 prevents fluid from entering the area between the contact surface 103A₁ and 103B₁ and respective spool surfaces. The seal may be in the form of an O-ring 115 arranged around the circumference of the spool 110. In an embodiment, at least one of the contact surfaces 110A, 110B, 103A₁ or 103B₁ may have a minimized surface area to prevent changes in the latching effects. This minimized surface area can be any combination of the contact surfaces, for example, contact surface 110A and 103B₁. In embodiments, only one of the facing surfaces has a minimized contact surface area; however, it is contemplated that both facing surfaces may include a combination of minimized contact surface areas. This minimized surface area may additionally assist in the drainage of oil between the contact surfaces to prevent oil from accumulating therebetween.

FIG. 1b shows an exploded view of FIG. 1a inside line A to A′. In FIG. 1b, the seal 115 is shown to be about the circumference of the spool 110 and in slidable contact with the wall of the bore 107. In this manner the seal 115 prevents or minimizes fluid from entering the area between either of the open coil assembly 103A and closed coil assembly 103B and either respective end of the spool 110. For example, the seal 115 prevents or minimizes fluid from entering (damning up) between the first solenoid contact surface 103A₁ and first spool contact surface 110A. The seal 115 may be arranged near the open coil assembly 103A and/or closed coil assembly 103B in contact with a portion of the spool 110. Additionally, the seal 115 may be used with or without the use of a minimized surface geometry. By providing the seal 115, the change in the latching effect due to fluid accumulation between the spool and end cap can be minimized or eliminated. This is useful, but not limited, to a position near the open coil assembly 103A.

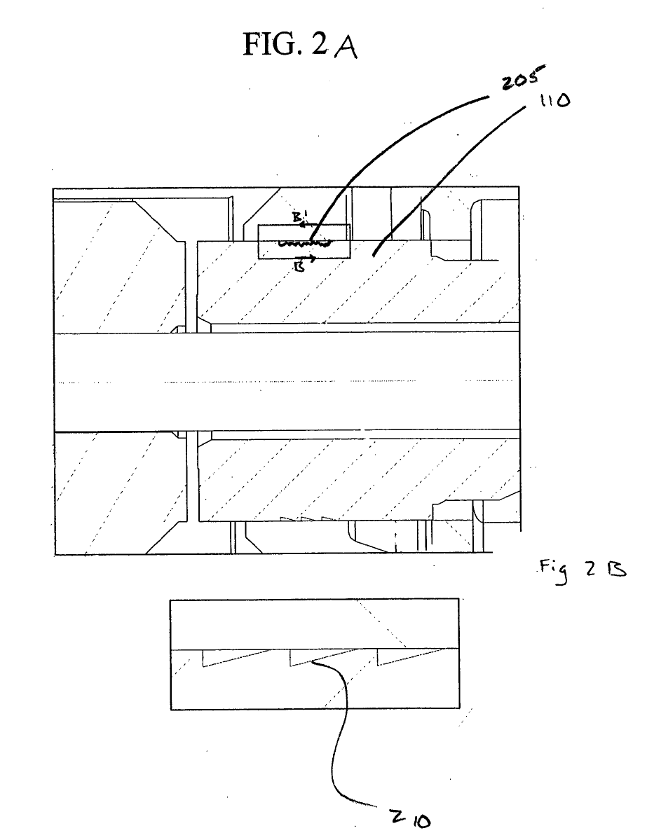

FIG. 2a shows a cross sectional view of a control valve body 100 according to another embodiment of the invention. In this embodiment, a geometric shape 205 is milled into a portion of the spool 110 near at least one of the open coil assembly 103A and/or the closed coil assembly 103B. The geometric shape 205 provides a pumping action that allows for fluid to be minimized or eliminated between the end cap and control valve body. That is, the geometric shape allows the fluid to be pumped back into either the inlet or drain of the control valve body. The geometric shape may be of any suitable configuration, for example, three triangular grooves 210 (FIG. 2b) that allow for a pumping of the fluid when the spool 110 is in motion. It should be well understood by those of ordinary skill in the art that the geometric shape may be two or other configuration of triangular grooves or other shapes which effectuate a pumping action.

The geometric shapes 205 may be positioned to a portion of the spool near any one of the open coil assembly 103A and closed coil assembly 103B. For example, the geometric shapes 205 may be positioned at a portion of the spool 110 near the open coil assembly 103A. Additionally, the geometric shapes 205 may be milled to any portion of the spool 110 such as, for example, around the entire circumference of the spool or around only a partial circumference of the spool 110. The geometric shapes 205 may be used with or without the use of a minimized surface geometry on the spool and/or end cap.

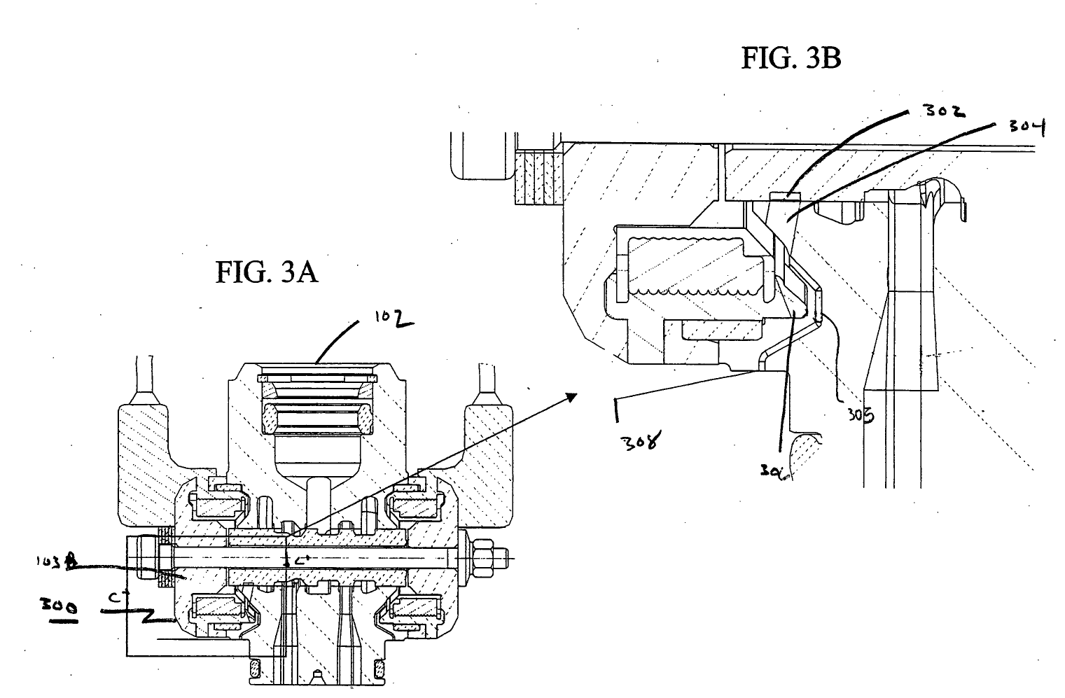

FIG. 3a shows a cross sectional view of a control valve body according to another embodiment of the invention. In this embodiment, a drainage system 300 is provided for eliminating or preventing fluid between the end cap 103A and control valve body 100. This embodiment also prevents or minimizes the fluid between the contact surfaces 110A, 110B, 103A₁ or 103B₁. The drainage system allows fluid to be removed or drained from the aforementioned regions. By providing the drainage system, the change in the latching effect can be minimized or eliminated. This is useful, but not limited, to the open side end cap. Additionally, when using the drainage system a seal may also be implemented as shown in FIG. 2a.

FIG. 3b shows an exploded view of FIG. 3a inside line C to C′. The drainage system includes a groove 302 arranged on at least a portion of the spool 110. For example, the groove 302 may be arranged around an entire circumference of the spool 110. In an embodiment, the groove, alone, may prevent fluid accumulation. A drain hole 304 provided in a portion of the control valve body is aligned with at least a portion of the groove 302 at a certain instance during a movement of the spool. The drain hole 304 is in fluid communication with a drainage passageway 305 for draining through an end cap protrusion 306.

The location and size of drain hole 304 is arranged in order to provide for optimized draining. For example, the groove 302 and drain hole 304 may be arranged below a portion of the spool 110 near the open coil assembly 103A and/or closed coil assembly 103B. A modified intensifier and shim 308 may be used for increasing the flow path of the excess fluid. Accordingly, the drainage system 300 allows for the minimization or elimination fluid between the end cap and control valve body to be eliminated via the groove 302 and drain hole 304. Optionally, the drainage system may be used with a minimized surface geometry on the spool and/or end cap. Additionally, the drain system 300 may be used with the seal and/or geometric shapes for preventing fluid entering the area between the end cap and spool.

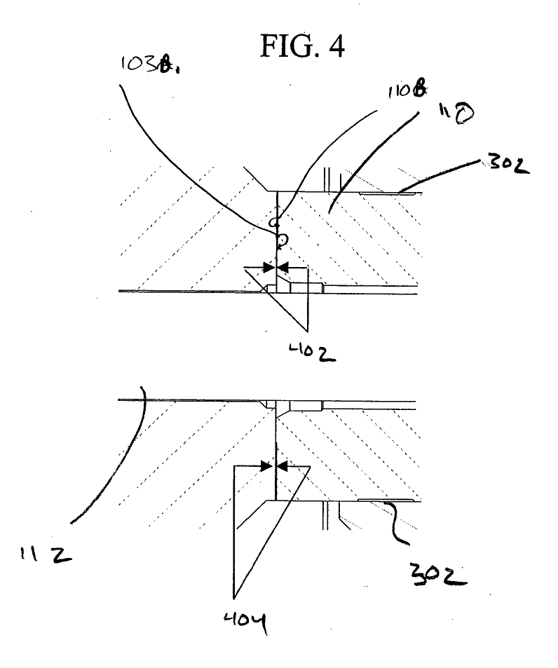

FIG. 4 shows an exploded cross sectional view of a minimized surface area which may be implemented with the invention. Referring to FIG. 4, reference number 402 generally represents a contact area of the first spool contact surface 110A and a portion of the first solenoid contact surface 103A₁. Reference number 404 generally represents a non-contact area of the spool and end cap, which may include, in embodiments, the first solenoid contact surface 103A₁ and the spool contact surface 110A. In this manner the invention provides for a minimized surface area between the spool and the end cap. This minimized surface area may be formed, in embodiments, by at least one raised portion or a recessed portion on any of the contact surfaces. This portion contributes to a non-contact area (e.g., a gap) between the spool 110 and the end cap. In one embodiment, for example, this gap may be approximately 30 μm. By providing this minimized contact area, the change in the latching effect can be minimized or eliminated by reducing, for example, a fluid film between the spool and end cap, itself, or a vacuum or a magnetic adhesion.

It should be understood by one of ordinary skill in the art that the magnetic forces are typically higher at the outside edges of the spool. This results in a higher “pulling” force of the spool. By moving the contact portion to only the outer portion, there is also a larger surface contact area, compared to only on the inner-more portion. This results in a greater pulling force, while maintaining the required minimum ratio of the surface area versus boundary line of the surface.

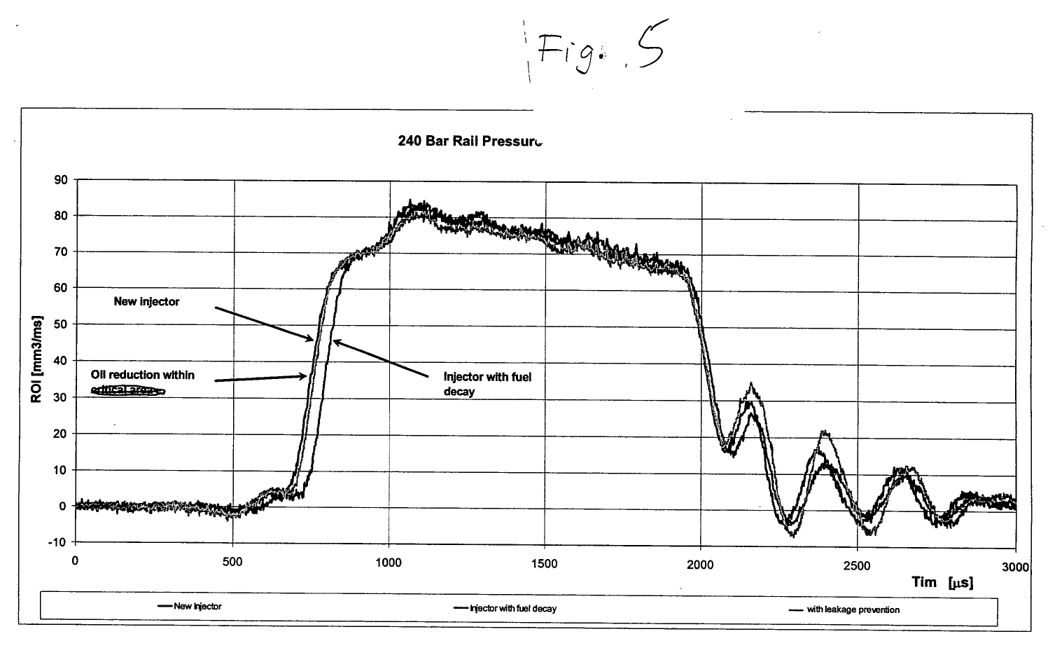

FIG. 5 shows a graph comparing the rate of injection (ROI) versus time with various injectors at a rail pressure of 240 bars. This graph demonstrates that the injector in accordance with features of the invention performs substantially the same as that of a new fuel injector. That is, the injector according to the aspects of the invention has a substantially superior performance over time; whereas a known injector (injector with fuel decay) over time shows decreased performance or fuel decay. The fuel decay injectors (e.g., defective injectors) can be restored by applying any combination of a seal, various geometric shapes milled onto a portion of the spool or a drainage system. After restoration, the reoccurrence of decay is substantially minimized or eliminated.

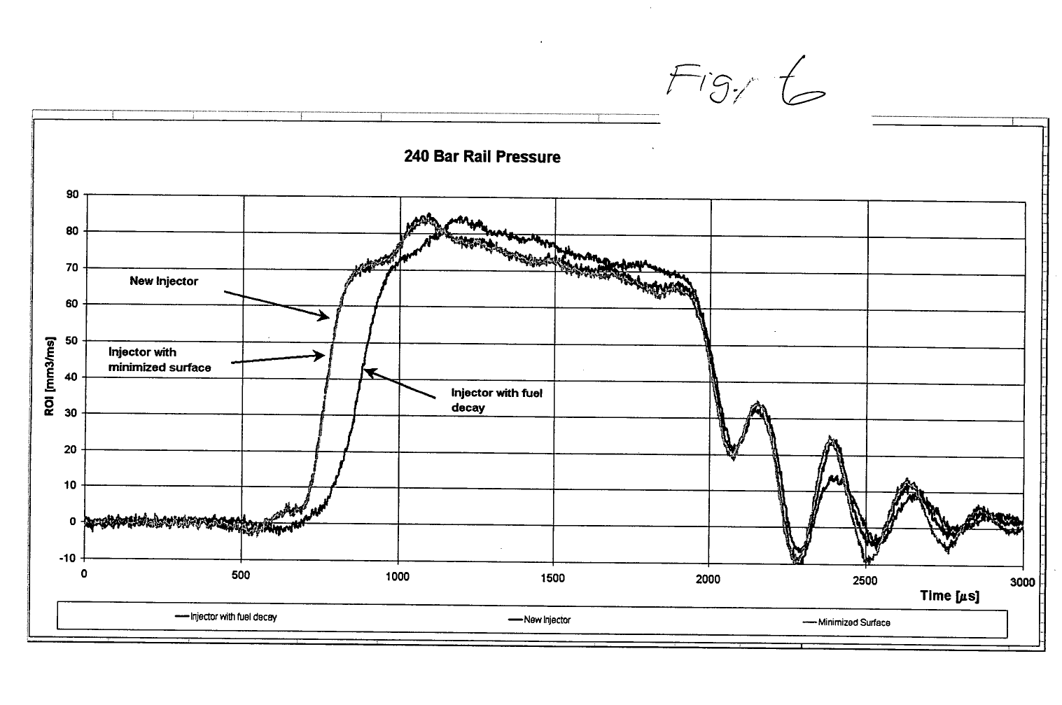

FIG. 6 shows a graph comparing the rate of injection (ROI) versus time with various injectors at a rail pressure of 240 bars. This graph demonstrates an injector with a minimized surface area being substantially the same as that of a new fuel injector. The injector according to the aspects of the present invention has a substantially superior performance over time; whereas a known injector (used injector) over time shows decreased performance or fuel decay. The fuel decay injectors (e.g., defective injectors) can be restored by applying the minimized surface areas as discussed throughout. After restoration, the reoccurrence of decay is substantially minimized or eliminated.

### Operation of the Oil Activated Fuel Injector of the Invention

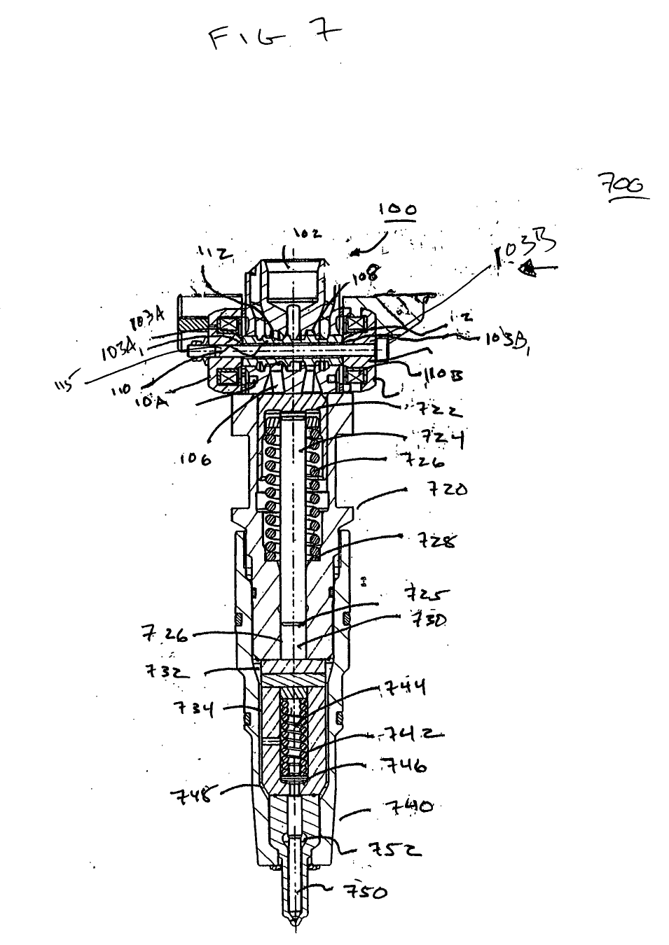

FIG. 7 shows an overall view of a fuel injector assembly 700. An intensifier body 720 is mounted to the valve control body 100 via any conventional mounting mechanism. A piston 722 is slidably positioned within the intensifier body 720 and is in contact with an upper end of a plunger 724. An intensifier spring 726 surrounds a portion (e.g., shaft) of the plunger 724 and is further positioned between the piston 722 and a flange or shoulder 728 formed on an interior portion of the intensifier body 720. The intensifier spring 726 urges the piston 722 and the plunger 724 in a first position proximate to the valve control body 100. In general, a high-pressure chamber 730 is formed by an end portion 725 of the plunger 724 and an interior wall 726 of the intensifier body 720.

The nozzle 740 includes a fuel inlet 732 in fluid communication with the high-pressure chamber 730 and a fuel bore 734. It should be recognized that the fuel bore 734 may be straight or angled or at other known configuration. This fluid communication allows fuel to flow from the high-pressure chamber 730 to the nozzle 740. A spring cage 742, which typically includes a centrally located bore, is bored into the nozzle 740. A spring 744 and a spring seat 746 are positioned within the centrally located bore of the spring cage 742. The nozzle 740 further includes a bore 748 in alignment with the bore 734. A needle 750 is preferably centrally located with the nozzle 740 and is urged downwards by the spring 744. A fuel chamber 752 surrounds the needle 750 and is in fluid communication with the bore 748.

In operation, a driver (not shown) will first energize the coil. The energized coil will then shift the spool to an open position. In the aspects of the invention, any combination of the seal, geometric surface, drainage system and minimized contact surface areas, for example, the O-ring arranged on a portion of the spools may be used for eliminating or preventing fluid accumulation to substantially prevent any change in the latching effect. In the open position, the grooves will overlap to provide a fluid path for the working fluid to flow from the inlet port to the working ports. At this stage, the seal, geometric surface or drainage system will prevent or eliminate the accumulation of the fluid.

Once the pressurized working fluid is allowed to flow into the working port 106 it begins to act on the piston and the plunger. That is, the pressurized working fluid will begin to push the piston and the plunger downwards thus compressing the intensifier spring. As the piston is pushed downward, fuel in the high-pressure chamber will begin to be compressed via the end portion of the plunger. A quantity of compressed fuel will be forced through the bores into the chamber which surrounds the needle. As the pressure increases, the fuel pressure will rise above a needle check valve opening pressure until the needle spring is urged upwards. At this stage, the injection holes are open in the nozzle allowing a main fuel quantity to be injected into the combustion chamber of the engine.

To end the injection cycle, the driver will energize the closed coil. The magnetic force generated in the coil will then shift the spool into the closed position. At this stage, the change in the latching effect may also be minimized or eliminated by a minimized surface area or through the seal, geometric surface or drainage system. At this stage, the intensifier spring will urge the plunger and the piston into the closed or first position adjacent to the valve. As the plunger moves upward, fuel will again begin to flow into the high-pressure chamber of the intensifier body.

While the invention has been described in terms of embodiments, those skilled in the art will recognize that the invention can be practiced with modification within the spirit and scope of the appended claims.

1. A valve control body, comprising:
a control body;
opposing solenoid coils positioned at respective ends of the control body; and
a spool positioned within a bore of the control body and between the opposing solenoid coils, the spool including a mechanism which at least minimizes fluid accumulation between an end of the spool and at least one of the opposing solenoid coils.

2. The valve control body of claim 1, wherein the mechanism includes a seal seated within a groove of the spool and in slidable contact with a wall of the bore of the control body.

3. The valve control body of claim 2, wherein the seal is an O-ring arranged about a circumference of the spool.

4. The valve control body of claim 2, wherein the seal is positioned proximate to a first end of the control body.

5. The valve control body of claim 1, further comprising a minimized contact surface area between the spool and at least one of the opposing solenoid coils.

6. The valve control body of claim 1, wherein the mechanism is a geometric shape formed into a portion of the spool.

7. The hydraulically controlled valve control body of claim 6, wherein the geometric shape is a plurality of triangular shaped grooves.

8. The valve control body of claim 7, wherein the plurality of triangular shaped grooves provide a pumping of fluid away from at least one of the opposing solenoid coils.

9. The valve control body of claim 8, further comprising a minimized contact surface area between the spool and at least one of the opposing solenoid coils.

10. The valve control body of claim 1, further comprising a drainage system in fluid communication with the mechanism, the mechanism being a drainage groove formed about the circumference of the spool.

11. The hydraulically controlled valve control body of claim 10, wherein the drainage system comprises a drain arranged below a portion of the groove.

12. The valve control body of claim of claim 10, further comprising an intensifier and shim arranged below a portion of the groove for increasing a flow path of fluid.

13. A valve control body, comprising:
a control body;
a first solenoid coil positioned at a first end of the control body;
a second solenoid coil positioned at an opposing second end of the control body;
a spool positioned within the control body between the open and closed solenoid coils; and
means for minimizing fluid accumulation between a contact surface area between the spool and one of the first and second solenoid coils.

14. The valve control valve body of claim 13, wherein the means is a minimized surface area between the spool and one of the first and second solenoid coils.

15. The valve control valve body of claim 13, wherein the means is a seal positioned about a circumference of the spool and in slidable contact with a bore wall of the control body.

16. The valve control valve body of claim 13, wherein the means is a geometric shape milled into the spool for effectuating a pumping of fluid during a movement of the spool.

17. The valve control valve body of claim 13, wherein the means is a drainage system, the drainage system including a groove in the spool in slidable alignment with a drainage passageway.

18. The valve control valve body of claim 13, wherein the means prevents a latching effect between the spool and at least one of the first and the second solenoid coils.

19. A fuel injector, comprising:
a body control valve having an inlet port and working ports;
a first and second solenoid coil positioned at opposing ends of the body control valve;
a slidably mounted spool arranged substantially between the first and second solenoid coils, the spool including a mechanism which at least minimizes fluid accumulation between an end of the spool and at least one of the first and second solenoid coil;
an intensifier chamber having a piston and plunger assembly, the intensifier chamber being in fluid communication with the working ports;
a high-pressure fuel chamber arranged below a portion of the plunger; and
a needle chamber having a needle responsive to an increased fuel pressure created in the high-pressure fuel chamber.

20. The fuel injector of claim 19, wherein the mechanism is a seal seated within a groove of the spool and in slidable contact with the a bore wall of the control valve.

21. The fuel injector of claim 19, wherein the mechanism is a geometric shape formed into a portion of the spool.

22. The fuel injector of claim 19, further comprising a minimized contact surface area between the spool and at least one of the opposing solenoid coils.

23. The fuel injector of claim 19, further comprising a drainage system in fluid communication with the mechanism, the mechanism being a drainage groove formed about the circumference of the spool.

24. A replacement kit for a valve control body of a fuel injector, comprising:
a spool including an element for reducing or minimizing latching effects between the spool and end caps of the fuel injector.

25. The replacement kit of claim 24, wherein the element is one of a seal arranged about the spool and a geometric shape in the spool which pumps fluid away from at least one of the end caps of the fuel injector.
